(19) United States
(12) Patent Application Publication
(10) Pub. No.: US 2009/0294526 A1
(43) Pub. Date: Dec. 3, 2009

(54) TESTING CAPABILITY ALLOWING NEW DATA TAGS

(75) Inventor: Brian Maw, Belmont, CA (US)

Correspondence Address: Visa USA c/o Duane Morris LLP;Attn: James Sze, Esq., 101 West Broadway, Suite 900, San Diego, CA, 92101, US

(73) Assignee: VISA U.S.A. Inc., San Francisco, CA (US)

(21) Appl. No.: 12/472,028

(22) Filed: May 26, 2009

Related U.S. Application Data
(60) Provisional application No. 61/056,297, filed on May 27, 2008.

(51) Int. Cl. G06K 5/00

(52) U.S. Cl. 235/380

(57) ABSTRACT

A method of testing a payment device reader includes receiving data from the payment device reader, combining the received data with data for a first testing scenario, transmitting the combined data to a payment processor, receiving an authorization decision from the payment processor, and displaying the results of the authorization decision on a display. The first testing scenario is selected from a plurality of testing scenarios stored in the computer readable storage medium. Each of the plurality of testing scenarios includes data for emulating a device for performing a financial transaction located at one of a merchant, an acquirer, or an issuer.

### CROSS-REFERENCE TO RELATIONS APPLICATIONS

This application claims priority to U.S. Provisional Patent Application No. 61/056,297, filed May 27, 2008, the entirety of which is incorporated by reference herein.

### BACKGROUND

Aspects of the present disclosure relate in general to financial services. Aspects include a system, method, and computer-readable storage medium configured to perform testing of contactless payment centers for payment cards or devices.

Credit and/or debit card readers are constantly being updated to enable the processing of additional information stored on credit cards. For example, some credit cards now contain information about frequent flyer miles, cash back options, or other combinations of rewards and rebates in the credit cards.

The new credit card readers are designed to be able to detect and process this newly embedded information on the cards. However, the readers are manufactured by a third party and not by the payment processors, e.g., “VISA, INC™”, “MASTERCARD™”, “AMERICAN EXPRESS™”. While the manufacturer of the readers conducts testing of the readers to ensure proper electrical operation, the manufacturer does not perform end-to-end testing to ensure that information on the card will be properly transmitted and processed by acquirers, issuers, and payment processors when installed at a point-of-sale (POS).

Accordingly, a system and method of testing credit card readers is desirable.

### SUMMARY

A system, method, and computer readable storage medium to test a payment device or card reader end-to-end are described. In one embodiment, a method of testing a payment device reader includes receiving data from the payment device reader, combining the received data with data for a first testing scenario, transmitting the combined data to a payment processor, receiving an authorization decision from the payment processor, and displaying the results of the authorization decision on a display. The first testing scenario is selected from a plurality of testing scenarios stored in the computer readable storage medium. Each of the plurality of testing scenarios includes data for emulating a device for performing a financial transaction located at one of a merchant, an acquirer, or an issuer.

The above and other features of the present disclosure will be better understood from the following detailed description of the preferred embodiments of the invention that is provided in connection with the accompanying drawings.

### BRIEF DESCRIPTION OF THE DRAWINGS

The accompanying drawings illustrate embodiments of the disclosed system and method, as well as other information pertinent to the disclosure, in which:

FIG. 1 illustrates one example of a financial transaction network for performing a financial transaction using a payment device;

FIG. 2 is a block diagram of a payment processor configured to identify and/or record customer specific data on a payment device or card;

FIG. 3 is one example of a table showing tags of information on a payment device or card;

FIG. 4 illustrates one example of customer specific data storage on a payment device or card;

FIG. 5 illustrates one example of a test system configured to test a payment device or card reader;

FIG. 6 is a flow chart describing one example of testing a payment device or card reader; and

FIG. 7 is one example of an architecture of a testing device in accordance with FIG. 5.

### DETAILED DESCRIPTION

For the purposes of this document, a payment card may be any credit, debit, prepaid, smart card, or financial transaction identification card capable of storing customer specific data for use in a financial transaction.

A payment device may be any credit, debit, prepaid, or financial transaction device, mobile phone, or identification card capable of storing customer specific data for use in a financial transaction. Examples of payment devices include, but are not limited to, a radio frequency payment device (e.g., a “Visa payWave”), a mobile phone device, personal digital assistant (PDA), pager, a mini-card, micro tag, payment fob, or the like. It is understood that the embodiments described herein are only examples, and the methods described herein may be extended to include future payment devices.

A financial transaction may include any operation involving a payment device or card, whether a payment, reimbursement, or any other interaction using a payment device or card. A financial transaction may also include any credit, debit, or charge transactions.

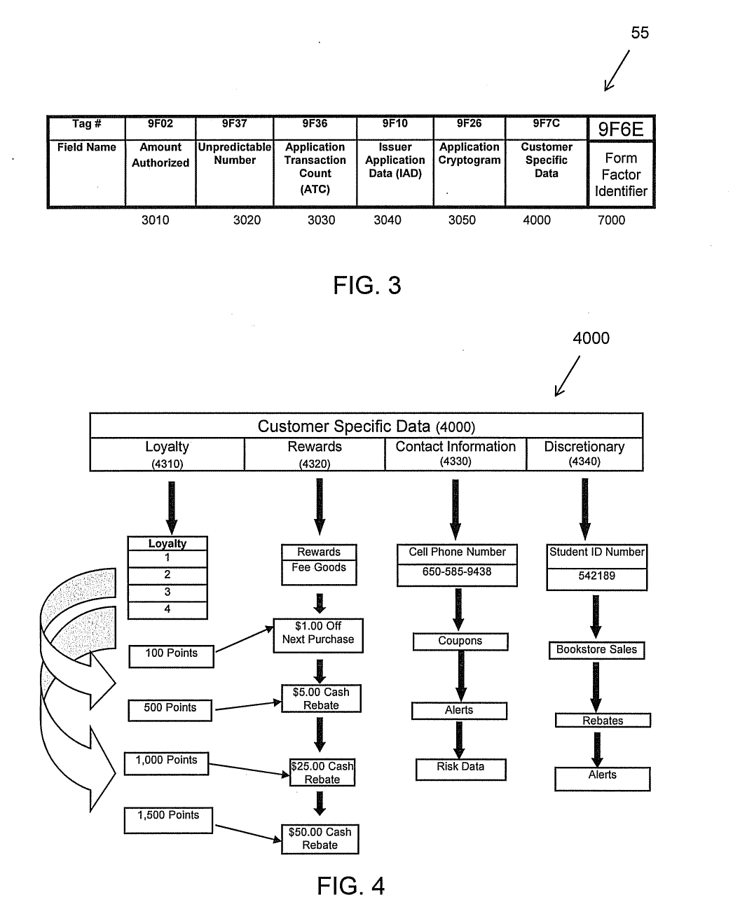

Payment devices/cards, which may have different form factors, may include various types of stored information. FIG. 3 depicts one example of a data field 55 (also referred to as “Field 55”) that may be stored on a payment device/card. In some embodiments, the memory field is in a computer chip within the payment device/card. Although implementations of Field 55 may vary in size, in some embodiments it may be limited to a maximum amount (e.g., 255 bytes) of data. One of the features of Field 55 is the ability to allow unique personalization values in the authorization messages that are transmitted between a payment processor 2000, a merchant 1100, acquirer 1200, and an issuer 1300. These values are also known as tags (also known as “data elements”) and support contactless financial transactions. Field 55 tags may include data embedded in the chip that an issuer requests to receive in the authorization message.

In one embodiment of Field 55, the Field 55 data elements may include: an amount authorized 3010 (tag 9F02), an unpredictable number 3020 (9F37), an application transaction counter (ATC) 3030 (tag 9F36), an issuer application data (IAD) 3040 (tag 9F10), an application cryptogram 3050 (tag 9F26), customer specific data 4000 (tag 9F7C), and a form factor identifier 7000 (tag 9F6E). Tag 9F7C carries customer specific data that issuer 1300 receives in an authorization request message during contactless transactions.

FIG. 4 illustrates examples of customer specific data 4000. Examples of customer specific data 4000 include, but are not limited to:

Loyalty and Coupons 4310
Instant information regarding coupons to customers while in the check out line at specific merchants.

Rewards 4320
Instant reward information or after-the-fact rewards and rebates based on marketing campaigns.
Provides flexibility that enables immediate rewards experience for the customer or following a promotional period.

Alerts and Contact Information 4330
Available for cardholders who desire immediate knowledge of purchases over specific amounts or transactions conducted in any country.
Provide the avenues necessary to establish contact with the cardholder at the point of sale, or thereafter, thus providing the capability to provide coupons, rewards, alerts, or the like.
Mode of contact may be through telephony, including wireless telephony, systems and databases.

Other Types of Data Including Issuer Discretionary Data 4340
Risk data, fraud information, exception data
Student ID
Drivers license number
Passport number
Social security number
Library card
Grocery club card or store card
Frequent flyer number or airline identification
Hotel rewards number or identification
Alternate cell phone number
E-mail address
Birthday
Zip code
Name of pet
Type of pet
Vehicle information
Gas card
Travel preferences
Shopping preferences

The form factor identifier field 7000 may include a plurality of pre-determined or reserved values for use of a full-size non-contactless payment card 100a, a full-size contactless payment card 100b, a non-contactless mini card 100d, a contactless mini card 100e, a micro tag 100e, a mobile device 100c, and alternate card users. Form factor identifier field 7000 may include some or all of the reserved values.

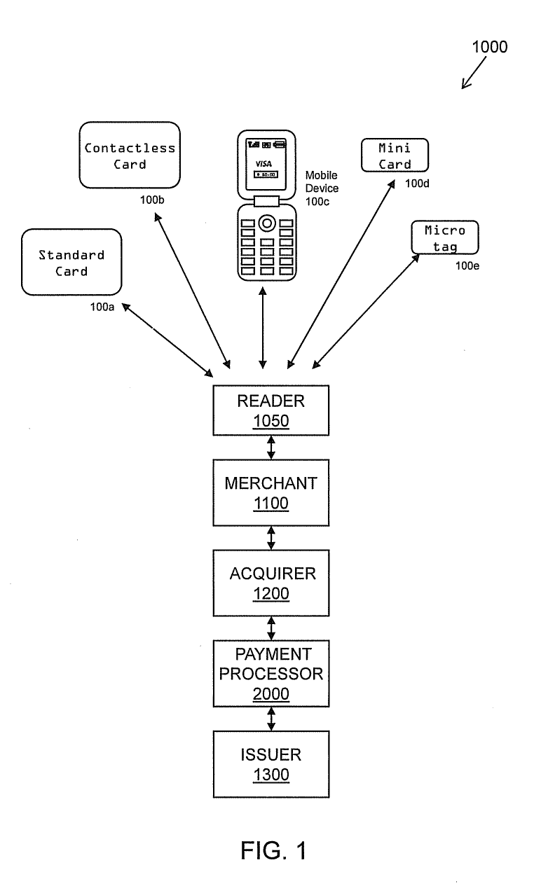

FIG. 1 illustrates a typical transaction involving a payment device/card 100. As illustrated in FIG. 1, a consumer will use the payment device/card 100 at a payment device/card reader or terminal 1050 located at a merchant 1100. For the purposes of this document, no distinction is made between a reader and a terminal although implementations may vary. In some embodiments, a reader and terminal may be implemented together as a single device. In some embodiments, the reader performs some processing and acts a pass-through and other processing intelligence is stored on the terminal. In some embodiments, the reader handles a majority of transaction processing and forwards the results to the terminal. One skilled in the art will appreciate that a number of other possible implementations exist.

The reader receives information from the device/card 100 which may include the information described above with respect to Field 55. The received information may be processed by a merchant and transmitted to an acquirer 1200 (for example, a commercial bank) to determine whether the consumer is credit worthy, whether the account has sufficient funds to pay for the transaction, or the like. The acquirer 1200 forwards the details of the payment transaction, including some merchant-specific data (e.g., name of merchant, location of merchant, transaction amount, etc.), to a payment processor 2000.

Payment processor 2000 may be a payment network such as, for example, VisaNet™ or other payment network. The payment processor 2000 is configured to parse and use the data stored on the payment device/card 100 in a financial transaction. The payment processor 2000 may then forward the parsed information to the payment card issuer 1300, which may be any financial institution or organization that issues the payment device/card 100. An issuer 1300 may have an authorization system including one or more computers or servers that receive the information from the payment processor 2000 and render an authorization decision.

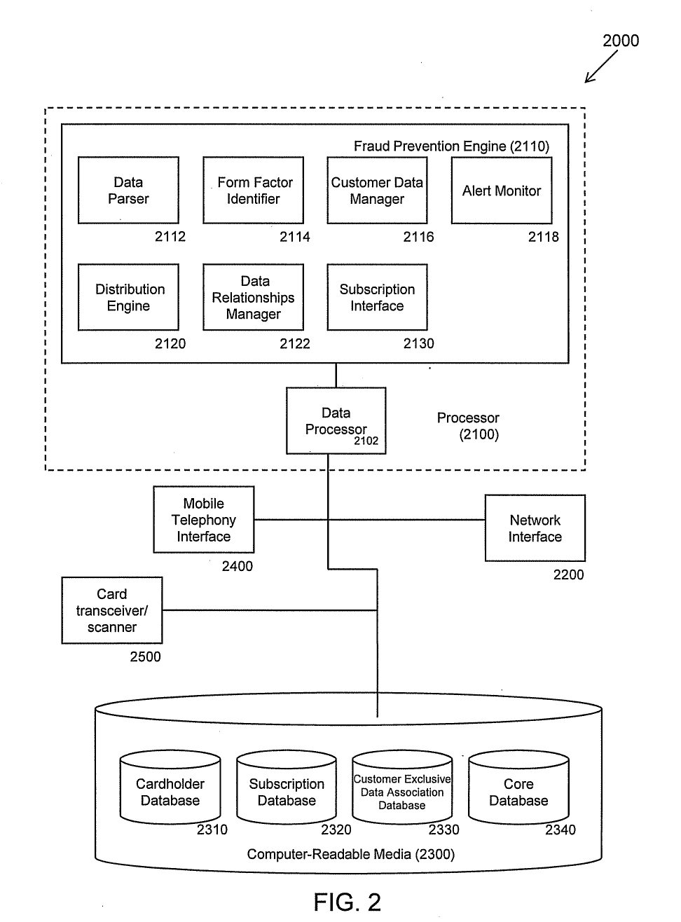

Payment processor 2000 is configured to associate customer specific data with a financial transaction during or after the transaction has taken place. FIG. 2 illustrates one example of a payment processor 2000. Payment processor 2000 may run a multi-tasking operating system (OS) and include at least one processor 2100. Processor 2100 may be any central processing unit (CPU), microprocessor, micro-controller, computational device or circuit.

As shown in FIG. 2, processor 2100 may include a fraud prevention engine 2110 and data processor 2102. Fraud prevention engine 2110 may include a data relationship manager 2122, a data parser 2112, a form factor identifier 2114, a customer data manager 2116, an alert monitor 2118, a distribution engine 2120, and a subscription interface 2130.

Data parser 2112 is configured to receive and parse financial transaction data. Form factor identifier 2114 enables fraud prevention engine 2110 to determine the form factor of the payment device/card 100. Customer data manager 2116 may be any structure, program, or module that enables fraud prevention engine 2110 to communicate with a cardholder database 2310. Alert monitor 2118 allows fraud prevention engine 2110 to generate fraud alerts. Distribution engine 2120 is configured to distribute transaction reports to issuers 1300. Data relationships manager 2122 associates customer specific data with a financial transaction after the transaction has taken place. Subscription interface 2130 allows issuers 1300 to subscribe to, and receive, the reports generated by distribution engine 2120. Each of these structures may be implemented as hardware, firmware, or software encoded on a computer readable medium, such as computer-readable storage media 2300.

Processor 2100 interfaces with storage medium 2300, network interface 2200, card transceiver/scanner 2500, and, in some embodiments, mobile telephony interface 2400. The data processor 2102 enables processor 2100 to locate data on, read data from, and write data to, these components.

Network interface 2200 may be any data port for interfacing, communicating, or transferring data across a computer network. Examples of such networks include, but are not limited to, Transmission Control Protocol/Internet Protocol (TCP/IP), Ethernet, Fiber Distributed Data Interface (FDDI), token bus, or token ring networks. Network interface 2200 allows payment processor 2000 to communicate with issuer 1300, and may allow communication with an acquirer 1200.

Computer-readable storage medium 2300 may be a read/write storage device such as a magnetic disk drive, floppy disk drive, compact-disk read-only-memory (CD-ROM) drive, digital versatile disk (DVD) drive, high definition digital versatile disk (HD-DVD) drive, blu-ray disk, magneto-optical drive, optical drive, flash memory, memory stick, transistor-based memory, or other computer-readable memory device for storing and retrieving data. Significantly, computer-readable storage medium 2300 may be remotely located from processor 2100 and be connected to processor 2100 via a network such as a local area network (LAN), a wide area network (WAN), the Internet, or other communication medium. In addition, as shown in FIG. 2, storage media 2300 may also contain a cardholder database 2310, a subscription database 2320, a customer specific data association database 2330, and a core database 2340.

Cardholder database 2310 contains cardholder information provided by an issuer 1300. Subscription database 2320 contains information about the reports, alerts, and other data subscriptions to which an issuer 1300 subscribes. Customer specific data relationship database stores information generated by data relationships manager 2122. Core database 2340 stores the subscription options that are requested by an issuer 1300.

Card transceiver/scanner 2500 may be any component capable of reading/writing data to or from payment device/card 100. For example, for conventional credit card 100a or mini-card 100d embodiments, card transceiver/scanner 2500 may read or write to a magnetic strip. Embodiments that communicate with a contactless card 100b, mobile phone 100c, and micro tag/key fob 100e include a wireless transceiver.

Mobile telephony interface 2400 is a wireless phone transceiver capable of communicating with mobile phone payment devices 100c. Wireless phone transceivers may communicate with any wireless telephony system. Such systems include, but are not limited to, digital cellular and personal communication systems (PCS). Message formats include, but are not limited to Enhanced Data Rates for Global Evolution (EDGE), General Packet Radio Service (GPRS), Wireless Internet (WAP), or any other mobile telephony standard.

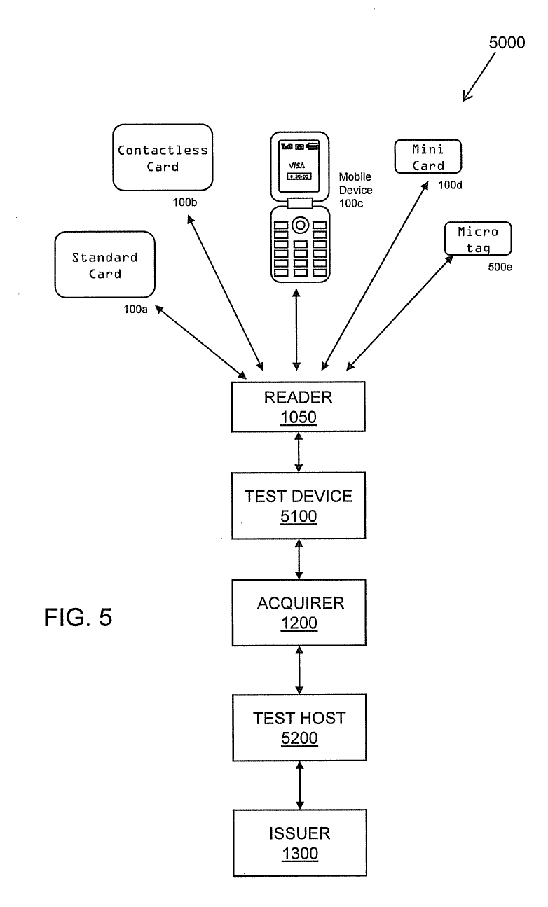

As new payment device readers are developed, they need to be tested to ensure that they properly extract information from the payment devices and properly interface with merchants, acquirers, payment processors, and issuers as described above. FIG. 5 illustrates one example of a testing system 5000 that may be used to test a payment device/card reader 1050. As shown in FIG. 5, testing system 5000 includes a payment device/card reader 1050 connected to a test device 5100. Test device 5100 may be any a workstation, computer, or device having a central processing unit (CPU), microprocessor, micro-controller, computational device or circuit.

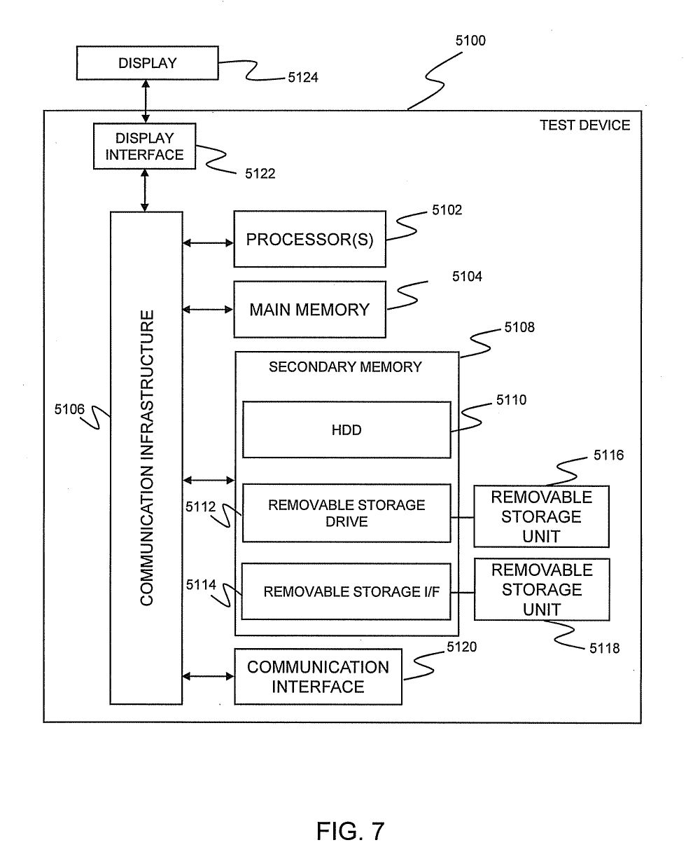

FIG. 7 is a block diagram of one example of a computer architecture of a testing device 5100. As shown in FIG. 7, testing device system 5100 may include one or more processors, such as processor(s) 5102. The processor(s) 5102 are connected to a communication infrastructure 5106 (e.g., a communications bus, cross-over bar, or network). Processor(s) 5102 may be configured to run any type of operating system including, but not limited to, Microsoft® Windows, Linux, UNIX, Mac OS X, FreeBSD®, and the like. Testing device 5100 can include a display interface 5122 that forwards graphics, text, and other data from the communication infrastructure 5106 (or from a frame buffer not shown) for display on the display unit 5124.

Testing device 5100 may also include a main memory 5104, such as a random access (RAM) memory, and may also include a secondary memory 5108. The secondary memory 5108 may include, for example, a hard disk drive 5110 and/or removable storage drive 5112, representing a floppy disk drive, a magnetic tape drive, an optical disk drive, or the like. The removable storage drive 5112 reads from and/or writes to a removable storage unit 5116 in a manner understood by those skilled in the art. Removable storage unit 5112 represents a floppy disk, magnetic tape, optical disk, or the like, which may be read by and written to by removable storage drive 5112. As will be appreciated, the removable storage unit 5116 may include a computer usable storage medium having stored therein computer software and/or data.

In some embodiments, secondary memory 5108 may include other similar devices for allowing computer programs or other instructions to be loaded into computer system 5100. Such devices may include, for example, a removable storage unit 5118 and a corresponding interface 5118. Examples of such units 5118 and interfaces 5114 may include a program cartridge and cartridge interface (such as that found in video game devices), a removable memory chip (such as an erasable programmable read only memory (EPROM), or programmable read only memory (PROM)) and associated socket, and other removable storage units 5118 and interfaces 5114, which allow software and data to be transferred from the removable storage unit 5118 to testing device 5100.

Testing device 5100 may also include a communications interface 5120. Communications interface 5120 allows software and data to be transferred between testing device 5100 and external devices, such as an acquirer 1200 and an issuer 1300. Examples of communications interface 5120 may include a modem, a network interface (such as an Ethernet card), a communications port, a Personal Computer Memory Card International Association (PCMCIA) slot and card, or the like. Software and data transferred via communications interface 5120 are in the form of signals, which may be electronic, electromagnetic, optical, or other signals capable of being received by communications interface 5120. These signals are provided to communications interface 5120 via a communications path or channel. The channel may be implemented using wire or cable, fiber optics, a telephone line, a cellular link, a radio frequency (RF) link or other communication channels.

In this document, the terms “computer program medium” and “computer readable medium” are to refer to media such as removable storage units 5116, 5118, a hard disk installed in hard disk drive 5110. These computer program products provide software to testing device 5100. Computer programs (also referred to as computer control logic) may be stored in main memory 5104 and/or secondary memory 5108. Computer programs may also be received via communications interface 5120. Such computer programs, when executed by a processor(s) 5102, enable the testing device 5100 to perform the features of the method discussed herein.

In an embodiment where the invention is implemented using software, the software may be stored in a computer program product and loaded into testing device 5100 using removable storage drive 5112, hard drive 5110, or communications interface 5106. The software, when executed by processor(s) 5102, causes the processor(s) 5102 to perform the functions of the method described herein.

In another embodiment, the method is implemented primarily in hardware using, for example, hardware components such as application specific integrated circuits (ASICs). Implementation of the hardware state machine so as to perform the functions described herein will be apparent to persons skilled in the art. In yet another embodiment, the method is implemented using a combination of both hardware and software.

Additionally, test device 5100 may be configured with one or more of a variety of peripheral ports such as, for example, a PS/2 port, an RS232 or serial port, a USB port, an IEEE 1284 or parallel port, a Peripheral Component Interconnect (PCI) slot, and an IEEE 1394 port to which the payment device/card reader 1050 may be connected.

Test device 5100 may be connected to an acquirer 1200, a test host 5200, and an issuer 1300 through a network connection. In some embodiments, test device 5100 may be configured to emulate a merchant POS terminal. In some embodiments, test device 5100 may be configured to emulate a system or device located at a merchant 1100 and an acquirer 1200 (e.g., a merchant POS terminal or a computer or server). In other embodiments, test device 5100 may be configured to emulate devices located at a merchant 1100, an acquirer 1200, and an issuer 1300. One skilled in the art will appreciate that test device 5100 may be configured to emulate devices at any number locations such as merchants, acquirers, and issuers.

In some embodiments, test host 5200 is a payment network such as, for example, VisaNet™, payment network operated by Visa, Inc. of San Francisco, Calif., and may include any of the features described above with respect to FIG. 2. In other embodiments, test host 5200 may be a computer, server, mainframe, or the like having an architecture similar to the architecture of the test device 5100 illustrated in FIG. 7, which may be configured to simulate a payment network.

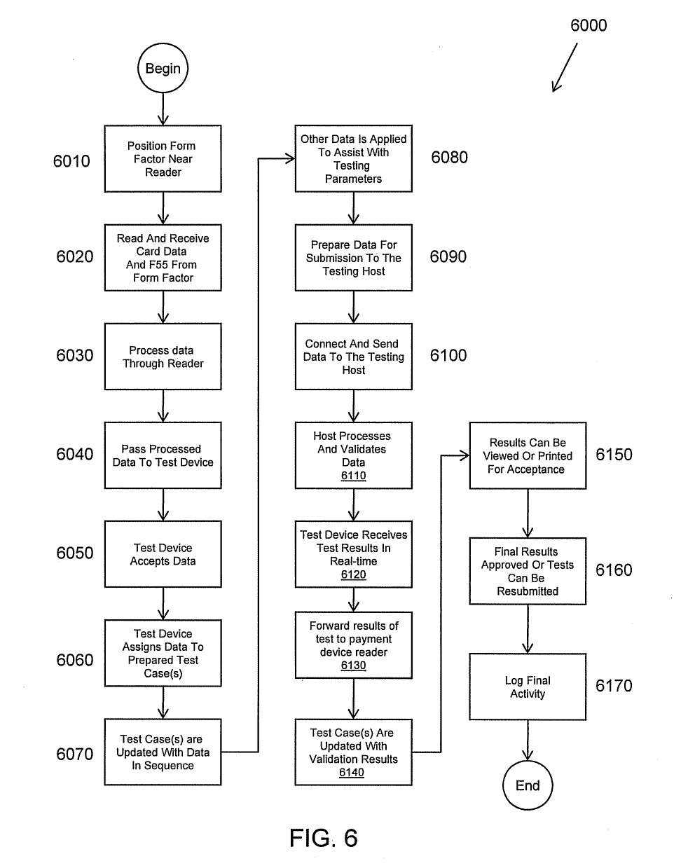

Turning to FIG. 6, a method for testing a payment device/reader 1050 in accordance with the embodiment shown in FIG. 5 is now described. Method 6000 begins by swiping a payment device/card 100 through a magnetic stripe reader 1050 or placing a payment device/card 100 in front of or near a contactless reader 1050 at block 6010. Payment device reader 1050 reads and receives the information stored on the payment device/card 100 including the data stored Field 55 at block 6020. At block 6030, the payment device reader 1050 processes the data and transmits the processed data to the test device 5100 at block 6040. As described above, the test device 5100 may be connected to the payment device reader 1050 through a PS/2 port, an RS232 or serial port, a USB port, an IEEE 1284 or parallel port, a Peripheral Component Interconnect (PCI) slot, an IEEE 1394 port, or an Ethernet or wireless network connection.

Test device 5100 accepts the data from the reader 1050 at block 6050 and assigns data to a predetermined test scenario that may be stored in a memory within test device 5100 at block 6060. For example, a test scenario may have test device 5100 emulating a merchant POS terminal 1100 in the United States for a predetermined transaction amount and perform the financial transaction with an acquirer 1200 and an issuer 1300. In other test scenarios, test device 5100 may emulate a merchant POS terminal 1100 located in a country foreign to the United States and perform the transaction with only an issuer 1300 based in the United States. One skilled in the art will appreciate that a large number of test scenarios may be stored in the computer readable medium, e.g., main memory 5104 or secondary memory 5108, of test device 5100.

At block 6070, a test scenario is updated with the data received from reader 1050. For example, certain data fields of a message are filled in using the data stored on the payment device/card 100 that is read by, and received from, the payment device reader 1050. Test device 5100 applies additional data to the test scenario at block 6080. For example, test device 5100 may assign or add data that it retrieves from its memory to the message such as merchant specific data including, but not limited to, a merchant name, merchant location, and transaction amount.

Test device 5100 prepares the data for submission to a testing host 5200 at block 6090. At block 6100, test device 5100 establishes a connection with test host 5200 and transits the test data to the test host 5200. The communication may be established using any communication protocol for communicating or transferring data across a computer network. Examples of such network protocols and networks include, but are not limited to, Transmission Control Protocol/Internet Protocol (TCP/IP), Ethernet, Fiber Distributed Data Interface (FDDI), token bus, or token ring networks.

Test host 5200 processes and validates the received data at block 6110. This may include transmitting a signal to an issuer 1300 or to the test device 5100, which may be emulating an issuer 1300, and receiving an authorization decision from the issuer 1300 or test device 5100 emulating the issuer 1300.

At block 6120, the test host 5200 transmits the processed and validated data to test device 5100 in real time. The test device 5100 may transmit a message to the payment device reader 1050 identifying the results of validation received from test host 5200. In some embodiments, the message transmitted to the reader 1050 may identify that the transaction was approved or declined to simulate an actual financial transaction at block 6130. In response, the payment device reader 1050 may display the message on a monitor, such as a touch screen interface.

At block 6140, the test scenario is updated with the results of the processing and validation performed by test host 5200. The results of the processing and validation may be stored in a database such as, for example, main memory 5104 or secondary memory 5108. If desired, the results of the testing scenario may be viewed on a monitor, e.g., display 5124, or printed by a printer connected to the test device 5100 at block 6150. The results of the testing scenario enable a card, reader, merchant, acquirer, payment processor, and issuer to be validated end-to-end, or additional testing may be initialized at block 6160. A log of the activities and transactions may also be created and stored in a database at block 6170. The results of a test scenario enable troubleshooting of a problem in a financial transaction. For example; if a test scenario is not successful, the results may identify the source of the problem such as a card or reader malfunction, merchant issue, acquirer processing issue, payment processing issue, issuer issue, or if hardware or configuration parameters of the host caused an error and need to be updated or changed.

In addition to the above described embodiments, the present disclosed method may be embodied in the form of a computer-implemented process for practicing those methods. The present disclosed method may also be embodied in the form of computer program code embodied in tangible media, such as floppy diskettes, read only memories (ROMs), CD-ROMs, hard drives, “ZIP™” high density disk drives, DVD-ROMs, blu-ray disks, flash memory drives, or any other computer-readable storage medium, wherein, when the computer program code is loaded into and executed by a computer, the computer becomes an apparatus for practicing the disclosed method. The present disclosed method may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the disclosed method. When implemented on a general-purpose processor, the computer program code segments configure the processor to create specific logic circuits.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method of testing a payment device reader, comprising:
receiving data from the payment device reader;
combining the received data with data for a first one of a plurality of testing scenarios, the first testing scenario selected from a plurality of testing scenarios stored in a computer readable storage medium, each of the plurality of testing scenarios including data for emulating a device for performing a financial transaction located at one of a merchant, an acquirer, or an issuer;
transmitting the combined data to a payment processor;
receiving an authorization decision from the payment processor; and
displaying the results of the authorization decision on a display.

2. The method of claim 1, further comprising:
storing the authorization decision in the computer readable storage medium to create a transaction log.

3. The method of claim 1, wherein the test data includes at least one of a merchant name, merchant location, and transaction amount.

4. The method of claim 1, wherein the data from the payment device reader includes Field 55 data.

5. The method of claim 4, wherein Field 55 data is selected from the group consisting of risk data, fraud information, exception data, student ID, drivers license number, passport number, social security number, library card number, grocery club card or store card number, frequent flyer number, hotel rewards number, cell phone number, e-mail address, birthday, zip code, name of pet, type of pet, vehicle information, and gas card number.

6. The method of claim 1, further comprising:
transmitting a message to the payment device reader in response to receiving the authorization decision from the payment processor, the message including the results of the authorization decision.

7. The method of claim 1, wherein the data received from the payment device reader includes data received by the payment device reader from a payment device.

8. A payment device reader testing system, comprising:
a computer readable storage medium including testing data; and
a processor in signal communication with the computer readable storage medium and a payment device reader, the processor configured to:
receive data from the payment device reader, the data including a form factor identifier;
combine the received data with data for a first testing scenario, the first testing scenario selected from a plurality of testing scenarios stored in the computer readable storage medium, each of the plurality of testing scenarios including data for emulating a device for performing a financial transaction located at one of a merchant, an acquirer, or an issuer;
transmit the combined data to a payment processor;
receive an authorization decision from the payment processor; and
display the results of the authorization decision on a display.

9. The testing system of claim 8, wherein the processor is configured to store the authorization decision in the computer readable storage medium.

10. The testing system of claim 8, wherein the test data includes at least one of a merchant name, a merchant location, and a transaction amount.

11. The testing system of claim 8, wherein the data from the payment device reader includes Field 55 data.

12. The testing system of claim 11, wherein Field 55 data is selected from the group consisting of includes risk data, fraud information, exception data, student ID, drivers license number, passport number, social security number, library card number, grocery club card or store card number, frequent flyer number, hotel rewards number, cell phone number, e-mail address, birthday, zip code, name of pet, type of pet, vehicle information, and gas card number.

13. The testing system of claim 8, wherein the data received from the payment device reader includes data received from a payment device.

14. The testing system of claim 8, wherein the processor is configured to transmit a message to the payment device reader in response to receiving the results of the authorization decision.

15. The testing system of claim 14, wherein the message includes the authorization decision.

16. A computer readable storage medium encoded with program code, wherein when the program code is executed by a processor, the processor performs a method, the method comprising:
receiving data from a payment device reader, the data including a form factor identifier;
combining the received data with data for a first testing scenario, the first testing scenario selected from a plurality of stored testing scenarios, each of the plurality of testing scenarios including data for emulating a device for performing a financial transaction located at one of a merchant, an acquirer, or an issuer;
transmitting the combined data to a payment processor;
receiving an authorization decision from the payment processor.

17. The computer readable storage medium of claim 16, wherein the test data includes at least one of a merchant name, merchant location, and transaction amount.

18. The computer readable storage medium of claim 16, wherein the data from the payment device reader includes Field 55 data.

19. The computer readable storage medium of claim 18, wherein Field 55 data is selected from the group consisting of risk data, fraud information, exception data, student ID, drivers license number, passport number, social security number, library card number, grocery club card or store card number, frequent flyer number, hotel rewards number, cell phone number, e-mail address, birthday, zip code, name of pet, type of pet, vehicle information, and gas card number.

20. The computer readable storage medium of claim 16, wherein the method includes transmitting a message to the payment device reader in response to receiving the authorization decision from the payment processor, the message including the authorization decision.
